(19) United States
(12) Patent Application Publication
(10) Pub. No.: US 2011/0110243 A1
(43) Pub. Date: May 12, 2011

(54) Method for Keeping Mobile Data Users Continuously Aware of Their Packet Data Utilization

(76) Inventor: Wendy Louise Call, Seattle, WA (US)

(21) Appl. No.: 12/614,270

(22) Filed: Nov. 6, 2009

(51) Int. Cl. H04L 12/26

(52) U.S. Cl. 370/252; 370/259

(57) ABSTRACT

This invention describes a new method for keeping a mobile user aware of the amount of data that he or she has transferred to or from a mobile device during the current subscription period (for example the current month, in the case of a month-by-month subscription plan). This will minimize the risk of the subscriber inadvertently exceeding his or her quota for data transfer during the current subscription period.

In the case of mobile voice service, some subscription plans include a fixed number of minutes of use during the weekday hours, and a possibly unlimited number of minutes of use in the evening and weekend hours. This type of metered service is easy for a consumer to comprehend, because it involves an intuitively obvious metric: minutes of use. It is possible, with some care, to avoid paying extra usage fees by ensuring that minutes of use don't exceed the amount included in the subscription plan.

In the case of packet data plans, the amount of data download or upload that a subscriber has consumed is not always obvious to the subscriber, because the unit of measurement is almost always bytes of data transferred, and the amount of data transferred could vary by several orders of magnitude depending on the device and the application (for example, text versus video).

Many mobile service providers have historically included unlimited data upload and download in their packet data subscription plans. As the volume of traffic per mobile device increases, more and more service providers could start to impose limits on the amount of data that a subscriber can upload and/or download per month.

Such limits, combined with the above-mentioned difficulty in measuring the actual volume of packet data transfer, could easily create a situation where subscribers are regularly exceeding the limits of their subscription plans without even realizing it.

The method described in this invention presents a simple method for continuously keeping subscribers appraised of their utilization relative to the maximum transfer amount included as part of their subscription plans. The subscribers can then adjust their usage patterns accordingly. And if they do exceed their utilization limits, it will be done deliberately and not accidentally.

We claim:

1. A mobile device used by a mobile subscriber to receive packet data service from a mobile network, said service including the download of data through said network to said mobile device, said network having placed a limit on the amount of data that can be downloaded during a given subscription period; where:
The download limit and the subscription period (for example start date of a monthly plan) have been stored as parameters in the mobile device, and
Said mobile device keeps a running counter of the amount of data that has been downloaded during the current subscription period, subtracting from the total traffic any overhead associated with the communication protocols of the network, and
Said mobile device presents to the subscriber the amount of data that has been downloaded during the current subscription period, and the maximum amount allowed.

2. The invention described in claim 1, where the amount of data transferred during the current subscription period is displayed as a bar graph, with the bar graph range extending from zero bytes up to the maximum amount of data transfer allowed during the current subscription period.

3. The invention described in claim 1, where the amount of data transferred during the current subscription period and the maximum transfer amount allowed are displayed as the numerator and denominator, respectively, of a fraction.

4. The invention described in claim 3, where the ratio of data transferred and maximum amount of transferred allowed is displayed as a percentage value between 0% and 100%.

5. The invention described in claim 1, where the traffic being measured is upload of data from the mobile device to the network.

6. The invention described in claim 1, where upload of traffic from mobile device to network, and download of traffic from network to mobile device are measured separately.

7. The invention described in claim 1, where the download limit and the subscription period are transferred to the mobile device from the mobile network.

8. The invention described in claim 7, where the traffic being measured is upload of data from the mobile device to the network.

9. The invention described in claim 7, where upload of traffic from mobile device to network, and download of traffic from network to mobile device are measured separately.

10. The invention described in claim 1, where the download limit and the subscription period are manually entered into the mobile device.

11. The invention described in claim 10, where the traffic being measured is upload of data from the mobile device to the network.

12. The invention described in claim 10, where upload of traffic from mobile device to network, and download of traffic from network to mobile device are measured separately.

13. The invention described in claim 1, where the mobile device is a mobile telephone.

14. The invention described in claim 1, where the mobile device is a Data Communication Equipment (DCE) connected to a computer.
